(19) United States
(12) Patent Application Publication
(10) Pub. No.: US 2009/0284868 A1
(43) Pub. Date: Nov. 19, 2009

(54) MAGNETIC RECORDING MEDIUM, MAGNETIC STORAGE APPARATUS AND MAGNETIC RECORDING MEDIUM MANUFACTURING METHOD

(75) Inventor: Yoshifumi Mizoshita, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/372,342

(22) Filed: Feb. 17, 2009

(30) Foreign Application Priority Data
May 15, 2008 (JP) 2008-128227

(51) Int. Cl. G11B 5/127; G11B 5/62; B32B 37/00

(52) U.S. Cl. 360/110; 428/848; 156/60

(57) ABSTRACT

A magnetic recording medium includes a first upper layer, a first lower layer below the first upper layer, an intermediate layer, provided between the first upper layer and the first lower layer, which magnetically couples the first upper layer and the first lower layer. The first lower layer includes a second upper layer, a second intermediate layer below the second upper layer, and a second lower layer below the second intermediate layer. Coercive force of the first upper layer is higher than coercive force of each of the second upper layer and the second lower layer. The second upper layer and the second lower layer are antiferromagnetically coupled via the second intermediate layer.

### CROSS-REFERENCE TO RELATED APPLICATIONS

This application is based upon and claims the benefit of priority of the prior Japanese Patent Application No. 2008-128227, filed on May 15, 2008, the entire contents of which are incorporated herein by reference.

### FIELD

The example discussed herein relates to a magnetic recording medium, a magnetic storage apparatus and a magnetic recording medium manufacturing method.

### BACKGROUND

For example, a discrete track magnetic recording medium has been proposed as a magnetic recording medium for a hard disk drive which is wide used as an external information recording unit for a computer or such. In the discrete track magnetic recording medium, a noise generated from the magnetic recording medium can be reduced.

Japanese Laid-Open Patent Publications Nos. 2003-16621, 62-239314 and 2002-203306, Japanese Patent No. 3421632, a homepage of Takahashi laboratory of Tohoku University (http://www. Takahashi.ecei.tohoku.ac.jp/docs/research/perp.htm, May 2, 2008) and “Ultra High-Density Perpendicular Magnetic Recording Medium Technologies for Hard Disk Drives”, pages 53-60 of FUJITSU.58, 1, January, 2007, discuss related arts.

### SUMMARY

In each embodiment, a magnetic recording medium includes a first upper layer, a first lower layer below the first upper layer, an intermediate layer, provided between the first upper layer and the first lower layer, which magnetically couples the first upper layer and the first lower layer. The first lower layer includes a second upper layer, a second intermediate layer below the second upper layer, and a second lower layer below the second intermediate layer. Coercive force of the first upper layer is higher than coercive force of each of the second upper layer and the second lower layer. The second upper layer and the second lower layer are antiferromagnetically coupled via the second intermediate layer.

It is to be understood that both the foregoing general description and the following detailed description are exemplary and explanatory only and are not restrictive of the invention, as claimed.

### BRIEF DESCRIPTION OF DRAWINGS

FIG. 1 depicts a sectional view of a magnetic recording medium in an embodiment 1;

FIGS. 2A, 2B, 2C, 2D, 2E, 2F and 2G illustrate a method for manufacturing the magnetic recording medium according to the embodiment 1;

FIGS. 3 and 4 illustrate generation of a magnetic domain at a guard track;

FIG. 5 depicts a sectional view for illustrating a configuration of a recording layer in the magnetic recording medium according to the embodiment 1;

FIG. 6 illustrates a function of avoiding generation of a magnetic domain at a guard track according to the embodiment 1;

FIGS. 7A, 7B, 7C, 7D and 7E illustrate a method for manufacturing a magnetic recording medium according to an embodiment 2;

FIG. 8 depicts an internal partial side elevation of a magnetic storage apparatus according to an embodiment 3; and

FIG. 9 depicts an internal partial plan view of the magnetic storage apparatus according to the embodiment 3.

### DESCRIPTION OF EMBODIMENTS

In a hard disk drive, information is written in a concentrically configured data track which is formed in a magnetic recording medium, with the use of a recording and reproducing magnetic head (simply referred to as a magnetic head, hereinafter) A case may be assumed in which, in a case where a width of the data track is very small, a magnetic field leaking from the magnetic head erases information recorded in an adjacent data track, or signal degradation occurs when information is reproduced from the adjacent data track. Further, in a process of reading a signal from the magnetic recording medium, a magnetic field leaking from the adjacent data track may cause a noise, whereby a reading error may occur.

In the hard disk drive, it is necessary to reduce the width of the data track to increase a recording density, which may result in track crosstalk.

In order to solve the problem mentioned above, the above-mentioned discrete track magnetic recording medium may be proposed. In the discrete track magnetic recording medium, a guard track is provided between adjacent data tracks, for reducing track crosstalk.

In the embodiments which will be described below, it is an object to provide a magnetic recording medium, a magnetic storage apparatus using the magnetic recording medium and a magnetic recording medium manufacturing method for manufacturing the magnetic recording medium, wherein a noise being generated from the magnetic recording medium can be effectively reduced.

In the embodiments, a magnetic recording medium includes a first upper layer, a first lower layer below the first upper layer, an intermediate layer, provided between the first upper layer and the first lower layer, which magnetically couples the first upper layer and the first lower layer. The first lower layer includes a second upper layer, a second intermediate layer below the second upper layer, and a second lower layer below the second intermediate layer. Coercive force of the first upper layer is higher than coercive force of each of the second upper layer and the second lower layer. The second upper layer and the second lower layer are antiferromagnetically coupled via the second intermediate layer.

Thus, in the embodiments, in the first lower layer, the second upper layer and the second lower layer are antiferromagnetically coupled via the second intermediate layer. As a result, generation of a magnetic domain in the first lower layer is effectively reduced, and it is possible to obtain a sufficient S/N from a magnetic storage apparatus which uses the magnetic recording medium.

Even when the above-mentioned magnetic recording medium is such that, a discrete track configuration is used in a magnetic recording medium having a so-called ECC (i.e., Exchange Coupled Composite) configuration, it is possible to provide a magnetic recording medium from which a sufficient S/N can be obtained.

The embodiments will now be described in detail.

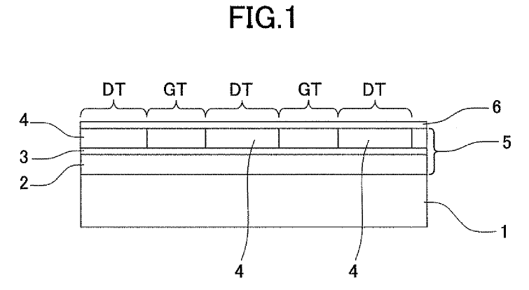

FIG. 1 depicts a sectional view of a configuration of a part of a magnetic recording medium according to an embodiment 1. As depicted in FIG. 1, the magnetic recording medium according to the embodiment 1 has a laminated structure which includes a lower soft magnetic layer 1, a recording layer 5 provided above the lower soft magnetic layer 1 and an overcoat layer (which may also be referred to as a protective layer) 6 provided above the recording layer 5. This magnetic recording medium is a perpendicular magnetic recording medium, and, as depicted in FIG. 1, has a discrete track configuration. In the discrete track configuration, a guard track GT is provided between each adjacent recording tracks DT as depicted in FIG. 1.

A perpendicular magnetic recording medium having the above-mentioned ECC configuration is described now. A perpendicular magnetic recording medium having the above-mentioned ECC configuration is referred to as a ECC perpendicular magnetic recording medium, which has a recording layer including two magnetic layers (i.e., a hard layer and a soft layer). The two magnetic layers are different in their respective ones of coercive force. Further, an exchange coupling control layer is provided which couples the two magnetic layers. In the above-mentioned soft layer which has smaller coercive force, a magnetization direction may be easily reversed or rotated when a magnetic field is applied by a magnetic head. Such a rotation of the magnetization direction is transmitted to the above-mentioned hard layer which has higher coercive force, via the exchange coupling control layer. In this state, corresponding magnetization rotation may relatively easily occur also in the hard layer. In this configuration, thermal stability is ensured, and also, side erase can be controlled.

Further, the above-mentioned discrete track magnetic recording medium is again described now. In the discrete track magnetic recording medium, in order to realize the above-mentioned configuration in which the guard track GT is provided between each adjacent data tracks DT, it is necessary to remove at least a part of the recording layer 5 at the position for each guard track GT. It is noted that, the magnetic recording medium depicted in FIG. 1 is one which is used in a hard disk drive. In a magnetic storage apparatus such as the hard disk drive, so-called a floating magnetic head is used. When at least a part of the recording layer 5 is removed as mentioned above for the purpose of providing the guard track GT, a problem may occur. That is, it is noted that at the position for each guard track GT, the surface of the magnetic recording medium may dent to form a groove, as a result of the at least a part of the recording layer 5 being removed as mentioned above. When such a groove is thus produced on the surface of the magnetic recording medium, floating characteristics of the above-mentioned floating magnetic head may degrade. Further, in the groove at the guard track GT, microscopic dust/dirt may be trapped, which may collide with the magnetic head.

In order to solve such a problem, the surface of the magnetic recording medium including the guard track GT may be planarized. Specifically, the groove of the guard track GT may be filled with non-magnetic material such as alumina to planarize the surface of the magnetic recording medium. However, in this method, a manufacturing process may become complicate. That is, a floating height of the floating magnetic head is, for example, 10 nm or such, and planarization in the order of nanometers may require very difficult and complicate processes.

In the embodiment 1, the above-mentioned problem is solved. That is, as depicted in FIG. 1, the above-mentioned recording layer 5 includes an upper hard layer 4 at an upper level, an exchange coupling control layer 3 at an intermediate level and a lower soft layer 2 at a lower level. Then, at a position for each guard track GT, only the upper hard layer 4 is removed by means of an ion mill or such. As a result of only the upper hard layer 4 being thus removed at the position for each guard track GT, the lower soft layer 2 is left. Thereby, the position for each guard track GT may be magnetically unstable. As a result, a magnetic domain may be generated in the lower soft layer 2, and thereby, when reading is carried out from the magnetic recording medium, a noise may be included in a read signal. If a noise is thus included in the read signal, the noise may cause an error in information obtained from the read signal. In the embodiment 1, as will be described later, such a problem is solved.

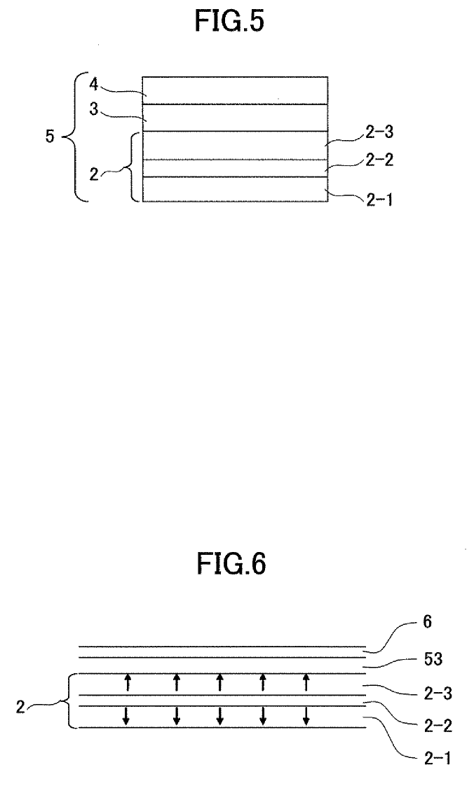

Thus, in the embodiment 1, as mentioned above, the recording layer 5 includes the upper hard layer 4, the exchange coupling control layer 3 and the lower soft layer 2. The recording layer 5 having such a configuration is referred to as a combined recording layer. Further, as will be described with reference to FIG. 5, the lower soft layer 2 includes an exchange coupling control layer 2-2 and two soft layers 2-1 and 2-3, between which the exchange coupling control layer 2-2 is inserted. The two soft layers 2-1 and 2-3, referred to as the lower soft layer 2-1 and the upper soft layer 2-3, respectively, are soft magnetic layers, respectively. In this configuration, a film thickness of the exchange coupling control layer 2-2 is adjusted so that the lower soft layer 2-1 and the upper soft layer 2-3 are coupled antiferromagnetically.

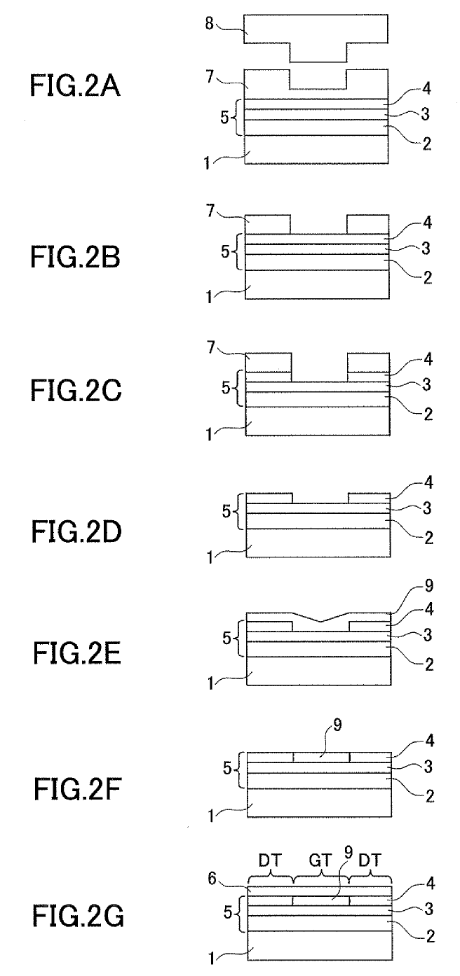

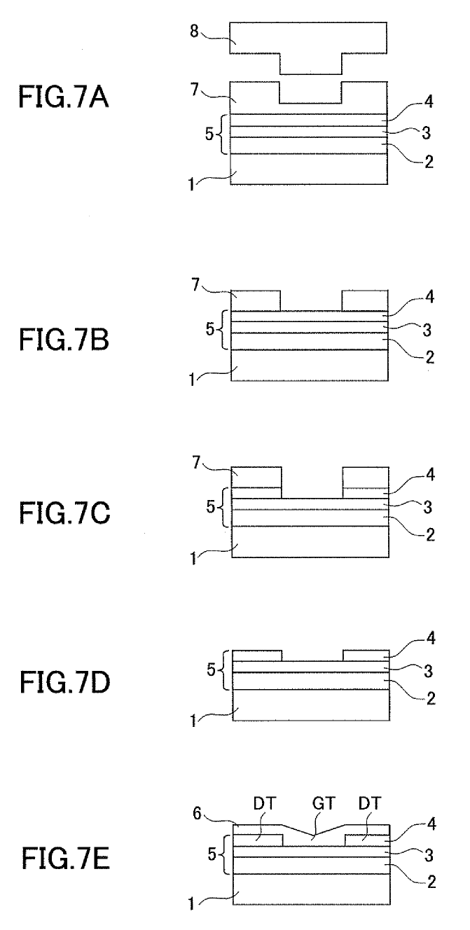

In the embodiment 1, as depicted in FIG. 1, the position for each guard track GT does not have the upper hard layer 4, but has the exchange coupling control layer 3 and the lower soft layer 2. That is, in the configuration of FIG. 1, the position for each recording track DT has a laminated structure including, from the top through the bottom, the overcoat layer 6, the upper hard layer 4, the exchange coupling control layer 3, the lower soft layer 2 and the lower soft magnetic layer 1. In contrast thereto, at the position for each guard track GT, the upper hard layer 4 is removed during a manufacturing process of the magnetic recording medium. As a result, the position for each guard track GT has a laminated structure including, from the top through the bottom, the overcoat layer 6, the exchange coupling control layer 3, the lower soft layer 2 and the lower soft magnetic layer 1. It is noted that, in the embodiment 1, at the position for each guard track GT at which the upper hard layer 4 has been removed as mentioned above, a layer 9 of non-magnetic material such as SiO₂ or Al₂O₃ is provided, as will be described later with reference to FIGS. 2A through 2G. Alternatively, in an embodiment 2 which will be described later with reference to FIGS. 7A through 7E, at the position for each guard track GT at which the upper hard layer 4 has been removed, the overcoat layer 6 is directly provided.

In the embodiment 1, when the upper hard layer 4 is removed at the position for each guard track GT which is inserted between each adjacent data tracks DT as mentioned above, a vacuum process according to an ion milling process or such may be used to remove the upper hard layer 4. Then, to each part from which the upper hard layer 4 has been thus removed, non-magnetic material is filled with as mentioned above, and then, the surface of the magnetic recording medium is planarized.

In the above-mentioned embodiment 2, when the upper hard layer 4 is removed at the position for each guard track GT with the use of a vacuum process according to an ion milling process or such, planarization after the removal of the upper hard layer 4 at the position for each guard track GT is not carried out, but the overcoat layer 6 is directly formed.

Thus, in each of the embodiments 1 and 2, the overcoat layer 6 may be formed at the highest position.

Further, in each of the embodiments 1 and 2, coercive force of each of the upper and lower soft layers 2-1 and 2-3 may be a third (or, equal to or less than the third) of coercive force of the upper hard layer 4.

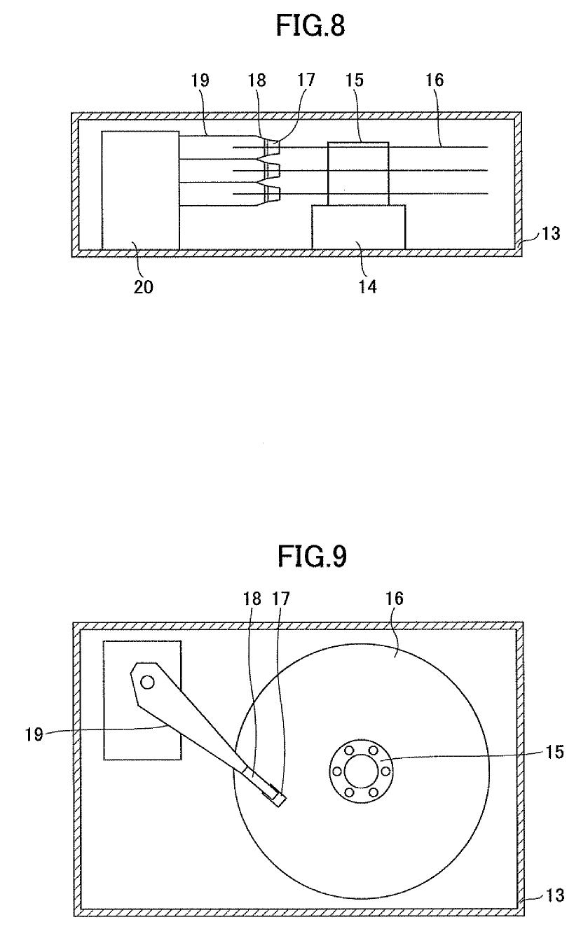

Further, as will be described later with reference to FIGS. 8 and 9, as an embodiment 3, a magnetic storage apparatus (for example, a hard disk drive) with the use of the magnetic recording medium having any one of the above-mentioned configurations may be realized.

The configurations of the above-mentioned embodiments 1 and 2, each of which may be used as a magnetic disk in a hard disk drive, will be described in detail.

It is noted that, generally speaking, commonly perpendicular magnetic recording is carried out in hard disk drives. Further, a magnetic recording medium having the above-mentioned ECC configuration has been developed recently. In each of the embodiments 1 and 2, based on a basic concept of the ECC configuration, the upper recording layer (i.e., the upper hard layer 4) which has higher coercive force is provided, while the lower recording layer (i.e., the lower soft layer 2) which has relatively lower coercive force is provided. Then, the upper hard layer 4 and the lower soft layer 2 are coupled via the exchange coupling control layer 3 which has a configuration of an electrically conductive thin film made of Ru or such. By adjusting a film thickness of the electrically conductive thin film of the exchange coupling control layer 3, the upper hard layer 4 and the lower soft layer 2 are magnetically coupled appropriately. As a result, it is possible to provide a superior magnetic recording medium in which information can be recorded with a reduced recording magnetic field.

According to each of the embodiments 1 and 2, a discrete track magnetic recording medium can be manufactured by a simple process, has improved manufacturability, and also, requires less manufacturing cost.

The magnetic recording medium in each of the embodiments 1 and 2 is a discrete track magnetic recording medium for a hard disk drive. The above-described discrete track configuration is also referred to as a data track separating configuration. The magnetic recording medium in each of the embodiments 1 and 2 has the recording layer 5 which includes the upper hard layer 4, the lower soft layer 2, and the exchange coupling control layer 3. The exchange coupling control layer 3 is inserted between the upper hard layer 4 and the lower soft layer 2, and is an electrically conductive thin film made of Ru or such. Further, as depicted in FIG. 5, the lower soft layer 2 includes the exchange coupling control layer 2-2, and includes the lower soft layer 2-1 and the upper soft layer 2-3, between which the exchange coupling control layer 2-2 is inserted. In the lower soft layer 2, the lower soft layer 2-1 and the upper soft layer 2-3 are antiferromagnetically coupled together as a result of a film thickness of the exchange coupling control layer 2-2 being optimized. Thus, the lower soft layer 2-1 and the upper soft layer 2-3 are coupled in such a manner that respective magnetization directions are reverse to one another. Thereby, generation of a magnetic domain from the lower soft layer 2 of the recording layer 5 can be inhibited. As a result, it is possible to reduce generation of a noise from the lower soft layer 2 of the recording layer 5, and it is possible to provide a magnetic recording medium for a hard disk drive from which a signal having an improved S/N can be obtained.

Further, in each of the embodiments 1 and 2, as will be described later with reference to FIGS. 2A through 2G and FIGS. 7A through 7E, in the combined recording layer 5, as depicted in FIG. 2G and FIG. 7E, the upper hard layer 4 is not provided at the position for each guard track GT between the recording tracks DT, but, at this position, the lower soft layer 2 and the exchange coupling control layer 3 are provided. As mentioned above, the lower soft layer 2 includes the exchange coupling control layer 2-2 and includes the lower and upper soft layers 2-1 and 2-3, between which the exchange coupling control layer 2-2 is inserted. The lower soft layer 2-1 and the upper soft layer 2-3 are antiferromagnetically coupled together as a result of the film thickness of the exchange coupling control layer 2-2 being optimized.

In this configuration of the magnetic recording medium for a hard disk drive, as mentioned above, in the combined recording layer 5 which includes the upper hard layer 4, the exchange coupling control layer 3 and the lower soft layer 2, the upper hard layer 4 is not provided at the position for each guard track GT, as depicted in FIG. 2G or FIG. 7E. Since the position for each guard track GT does not have the upper hard layer 4 to which a signal is recorded, crosstalk between each adjacent data tracks DT can be effectively reduced.

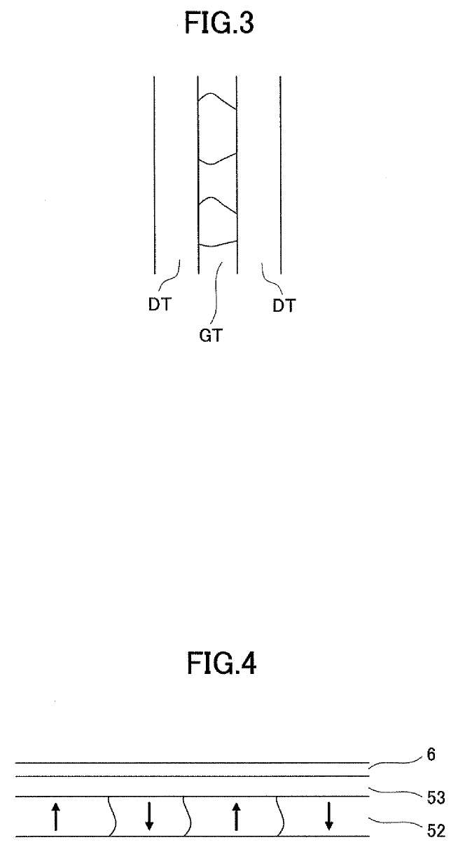

As depicted in FIG. 2G or FIG. 7E, as mentioned above, the position for each guard track GT does not have the upper hard layer 4 but has the lower soft layer 2 and the exchange coupling control layer 3. Therefore, as mentioned above and as will be described with reference to FIGS. 3 and 4, a magnetic domain may be easily generated, and a noise may be generated. In order to solve this problem, in each embodiment, as depicted in FIG. 5, the lower soft layer 2 includes the exchange coupling control layer 2-2 and includes the lower soft layer 2-1 and the upper soft layer 2-3, between which the exchange coupling control layer 2-2 is inserted. As mentioned above, as a result of the film thickness of the exchange coupling control layer 2-2 being optimized, the lower soft layer 2-1 and the upper soft layer 2-3 are antiferromagnetically coupled together. Such a configuration of the lower soft layer 2 will be referred to as an exchange coupled soft layer configuration, hereinafter. By using the exchange coupled soft layer configuration in each embodiment, it is possible to remarkably reduce generation of a noise from the lower soft layer 2 at the position for each guard track GT. As a result, it is possible to provide a discrete track magnetic recording medium for a hard disk drive from which a signal having an improved S/N can be obtained.

In the combined recording layer 5 of this configuration, the upper hard layer 4 is removed at the position for each guard track GT between the recording tracks DT, by a process such as ion milling, then, as depicted in FIG. 2E, non-magnetic material 9 is filled with, and, as depicted in FIG. 2F, planarization is carried out in the embodiment 1. In each embodiment, as the exchange coupling control layer 3 between the upper hard layer 4 and the lower soft layer 2, an electrically conductive thin film made of Ru or such may be used as mentioned above. In order to remove the upper hard layer 4 at the position for each guard track GT as mentioned above, etching may be carried out at the position for each guard track GT. By the etching, not only the upper hard layer 4 but also a part of the Ru layer of the exchange coupling control layer 3 may be removed so that some part of the Ru layer may be left unremoved. Further, as depicted in FIG. 2E and FIG. 2F, a part, from which material is thus removed by etching, is filled with the layer 9 of non-magnetic material such as SiO₂ or Al₂O₃, and then, planarization is carried on the surface in the embodiment 1.

The discrete track magnetic recording medium for a hard disk drive in this configuration has the recording layer 5 including the two layers of lower and upper recording layers 2 and 4, and the exchange coupling control layer 3 which is a electrically conductive member and is inserted between the two recording layers 2 and 4, as depicted in FIG. 2G or FIG. 7E. Further, as depicted in FIG. 2C or FIG. 7C, only the upper hard layer 4 (having a film thickness in a range between 5 and 10 [nm]) is removed by etching at the position for each guard track GT. Thus, the upper hard layer 4 which is the upper one of the two recording layers 2 and 4 is removed at the position for each guard track GT, for the purpose of forming a groove to separate each adjacent recording tracks DT to realize the above-mentioned discrete track configuration. In this process of removing the upper hard layer 4 at the position for each guard track GT, the Ru layer acting as the exchange coupling control layer 3 may be used as an etch stop. Thereby, it is possible to simplify a manufacturing process.

As a result of the upper hard layer 4 being thus removed at the position for each guard track GT, a difference in height or a step occurs between the guard track GT and the adjacent data track DT. In the configuration of the embodiment 1 depicted in FIGS. 2A through 2G, as mentioned above, the layer 9 of non-magnetic material such as SiO₂ or Al₂O₃ is filled with, and then, as depicted in FIG. 2F, planarization is carried out on the surface. As a result, it is possible to provide a magnetic recording medium having improved planarity on the surface, whereby floating characteristics of a floating magnetic head on the surface of the magnetic recording medium improves. Thus, it is possible to provide a highly reliable hard disk drive with the use of the magnetic recording medium in the embodiment 1. Further, in the configuration depicted in FIGS. 2A through 2G, a required amount of etching for removing the upper hard layer 4 at the guard track GT is very small. Further, a required amount of the non-magnetic material for the layer 9 to fill with after that is also very small.

Further, in the embodiment 2 depicted in FIGS. 7A through 7E, in the combined recording layer 5, after the upper hard layer 4 is removed by means of a vacuum process such as ion milling at the position for each guard track GT between the recording tracks DT as depicted in FIG. 7C, the overcoat layer 6 is formed directly without a process of planarization, as depicted in FIG. 7E. It is noted that, the upper hard layer 4 may be made into a thin film for the purpose of increasing a recording density of the magnetic recording medium. Specifically, the upper hard layer 4 may have a film thickness on the order of in a range between 5 and 10 [nm]. In the configuration of FIG. 7E, a difference in height or a step occurs between the data track DT and the adjacent guard track DT as mentioned above because the upper hard layer 4 is removed at the guard track GT. However, when the upper hard layer 4 is made into a thin film as mentioned above, the above-mentioned difference in height or step is reduced accordingly. In the magnetic recording medium in the embodiment 2, the above-mentioned difference in height or step may fall within a permissible range in terms of a floating amount of a floating magnetic head when the magnetic recording medium is used in a magnetic storage apparatus which uses the floating magnetic head which floats on the surface of the magnetic recording medium (i.e., a magnetic disk, for example).

In the embodiment 2 depicted in FIGS. 7A through 7E, it is possible to provide a highly practical magnetic recording medium by directly forming the overcoat layer 6 after removing the upper hard layer 4 at the position for each GT track, without filling with the layer of non-magnetic material, as mentioned above. That is, since it is possible to omit the process of filing with the layer of non-magnetic material to eliminate the difference in height or step between the guard track GT and the adjacent recording track DT, and also, it is possible to omit a process of planarization of the surface after that, it is possible to provide a discrete track magnetic recording medium for a hard disk drive having highly improved manufacturability.

In the magnetic recording medium in each embodiment described above, coercive force of the lower soft layer 2 is made lower than coercive force of the upper hard layer 4. Specifically, the coercive force of the lower soft layer 2 may be equal to or less than a third of the coercive force of the upper hard layer 4.

With reference to FIG. 1 and FIGS. 2A through 2G, a method for manufacturing a discrete track magnetic recording medium for a hard disk drive in the embodiment 1 will be described.

As depicted in FIG. 1 which depicts a sectional view taken along a section perpendicular to a track of a magnetic recording medium, in the discrete track magnetic recording medium for a hard disk drive, the recording layer 5 is separated by the guard tracks GT for the respective discrete data tracks DT. In order to industrially manufacture the discrete track magnetic recording medium for a hard disk drive, technology called nanoimprint technique may be used. Specifically, first a medium is manufactured, the medium includes the lower soft magnetic layer 1 and the recording layer 5 which are laminated together. The recording layer 5 includes the lower soft layer 2, the exchange coupling control layer 3 and the upper hard layer 4, which are laminated together. This medium may be manufactured by a well-known method, except manufacturing of the recording layer 5, for which a manufacturing method will be described later. Next, a resin layer 7 is coated onto the thus-obtained medium. Then, onto the medium onto which the resin layer 7 has been thus coated, as depicted in FIG. 2A, a mold 8, which has shapes like the guard tracks GT, is pressed. Thereby, grooves are formed on the surface of the resin layer 7 corresponding to the guard tracks GT, as depicted in FIG. 2A.

Next, as depicted in FIG. 2B and FIG. 2C, the resin layer 7 is used as a mask, and the upper hard layer 4 is removed at the position for each guard track GT, by a vacuum process such as an ion milling process. Further, as depicted in FIG. 2D, by means of a reactive ion milling process or such, a remaining part of the resin layer 7 is removed. Further, after that, the layer 9 of non-magnetic material, such as SiO₂ or Al₂O₃, is provided by means of a sputtering process or such (see FIG. 2E). Further, by means of a vacuum process such as an ion milling process, the surface is planarized (see FIG. 2F). Further, on top, the overcoat layer 6, which is a hard and thin layer, made of DLC (Diamond-Like Carbon) or such, is provided (see FIG. 2G).

In the recording layer 5 of the embodiment 1, the upper recording layer (i.e., the upper hard layer) 4 having high coercive force and the lower recording layer (i.e., the lower soft layer) 2 having relatively low coercive force are coupled together via the electrically conductive film (i.e., the exchange coupling control layer) 3 made of Ru or such. Further, as mentioned above, as depicted in FIG. 5, the lower soft layer 2 includes the exchange coupling control layer 2-2, and includes the lower soft layer 2-1 and the upper soft layer 2-3, between which the exchange coupling control layer 2-2 is inserted. The film thickness of the exchange coupling control layer 2-2 is adjusted so that the lower soft layer 2-1 and the upper soft layer 2-3 are antiferromagnetically coupled together. Thus, the lower soft layer 2 of the recording layer 5 has the above-mentioned exchange coupled soft layer configuration.

If the lower soft layer 2 of the recording layer 5 were a simple soft magnetic layer, as depicted in FIG. 3, a magnetic domain would be generated at the position for each guard track GT at which the upper hard layer has been removed as mentioned above (see FIG. 4, which depicts a sectional view). In FIG. 4, a reference numeral 6 represents an overcoat layer, a reference numeral 53 represents a non-magnetic layer and a reference 52 represents a lower soft layer. The magnetic domain might act as a source of a noise. According to the embodiment 1, as mentioned above, the lower soft layer 2 of the recording layer 5 has the exchange coupled soft layer configuration. As a result, as depicted in FIG. 6, by the function of the exchange coupling control layer 2-2, the lower soft layer 2-1 and the upper soft layer 2-3 are magnetized in mutually reverse directions, and thus, are antiferromagnetically coupled. In FIG. 6, a reference numeral 6 represents an overcoat layer and a reference numeral 53 represents a non-magnetic layer. As a result, generation of a magnetic domain in the lower soft layer 2 is inhibited.

That is, as mentioned above, in the discrete track magnetic recording medium for a hard disk drive according to the embodiment 1, in order to obtain a configuration of the guard track GT, the upper hard layer 4 is removed at the position or each guard track GT (see FIG. 2C). In this process, only the upper hard layer 4 is removed by means of etching, and a remaining part of the above-mentioned resin layer 7 is removed by means of a reactive ion milling process or such (see FIG. 2D). After that, the layer 9 of the non-magnetic material such as SiO₂ or Al₂O₃, is provided by means of sputtering (see FIG. 2E). Thereby, grooves formed as a result of the upper hard layer 4 being removed at the position for each the guard track GT is filled with. Further, the surface is planarized by means of a vacuum process such as an ion milling process (see FIG. 2F). Further, the overcoat layer 6, which is a hard and thin film, made of DLC or such, is provided on top.

Next, a method for manufacturing the discrete track magnetic recording medium for a hard disk drive in the embodiment 2 will be described with reference to FIGS. 7A through 7E. Respective processes depicted in FIG. 7A, FIG. 7B, FIG. 7C and FIG. 7D are the same as those of the embodiment 1 depicted in FIG. 2A, FIG. 2B, FIG. 2C and FIG. 2D, respectively. Therefore, duplicate description for the embodiment 2 will be omitted appropriately.

In the method for manufacturing the discrete track magnetic recording medium for a hard disk drive according to the embodiment 2, in order to obtain the guard tracks GT, the upper hard layer 4 of the recording layer 5 is removed at the position for each guard track GT. In this process, the same as in the case of the embodiment 1, only the upper hard layer 4 is removed by means of etching at the position for each guard track GT, and further, a remaining part of the resin layer 7 is removed by means of a reactive ion milling process or such (see FIG. 7C, FIG. 7D). In the method for manufacturing the discrete track magnetic recording medium for a hard disk drive according to the embodiment 2, after that, a series of processes including a process of producing the layer 9 of non-magnetic material such as SiO₂ or Al₂O₃ to fill the grooves with by means of sputtering and a process of planarization after that, included in the method for the embodiment 1, are not included. That is, in the method for manufacturing the discrete track magnetic recording medium for a hard disk drive according to the embodiment 2, after the above-mentioned process of removing the upper hard layer 4 at the position for guard track GT and then removing the remaining part of the resin layer 7, the overcoat layer 6 which is a hard and thin film made of DLC or such is directly provided on top (see FIG. 7E). As mentioned above, in the method for manufacturing the discrete track magnetic recording medium for a hard disk drive according to the embodiment 2, the process of planarizing the surface by means of a vacuum process according to an ion milling process or such can be omitted. As a result, it is possible to provide a practical method for manufacturing a discrete track magnetic recording medium for a hard disk drive.

Next, a method for manufacturing the recording layer 5 of the magnetic recording medium according to each of the embodiments 1 and 2 will be described.

As the lower soft layer 2-1 and the upper soft layer 2-3 included in the lower soft layer 2, which are soft layers included in the recording layer 5, films made of permalloy (i.e., Ni—Fe) or such may be used. Alternatively, in order to improve an S/N of a signal obtained from the recording layer 5, the lower soft layer 2-1 and the upper soft layer 2-3 may be formed by simultaneously sputtering a low coercive alloy of a family of cobalt-chrome (i.e., Co—Cr) and non-magnetic material such as SiO₂ or TiO₂. That is, it is preferable to use so-called granular thin films as the lower soft layer 2-1 and the upper soft layer 2-3 which are included in the lower soft layer 2.

Further, the exchange coupling control layer 3 of the recording layer 5 or the exchange coupling control layer 2-2 of the lower soft layer 2 of the recording layer 5 may be produced as a result of an electrically conductive film of Ru or such being produced with a film thickness of on the order of 1 nm. By controlling the film thickness of the exchange coupling control layer 3, strength of exchange coupling between the lower soft layer 2 and the upper hard layer 4, between which the exchange coupling control layer 3 is inserted, is optimized. Similarly, by controlling the film thickness of the exchange coupling control layer 2-2, strength of exchange coupling between the lower soft layer 2-1 and the upper soft layer 2-3, between which the exchange coupling control layer 2-2 is inserted, is optimized. As the film thickness, an optimum value may be determined as being different depending on specific material of the exchange coupling control layer 3 or 2-2.

The upper hard layer 4 may be made of material in a family of cobalt-chrome (i.e., Co—Cr), the same as the materials of the above-mentioned lower soft layer 2-1 and upper soft layer 2-3. Especially, the upper hard layer 4 may be made of a so-called granular thin film, obtained as a result of material having such an alloy composition, from which high coercive force is obtained, and non-magnetic material such as SiO₂ or TiO₂, being simultaneously sputtered.

Next, a method for manufacturing the overcoat layer 6 in each of the embodiments 1 and 2 will be described.

The overcoat layer 6 is used to protect the magnetic recording medium from being scratched, corrosion, or such. The overcoat layer 6 may be made of carbon having a diamond coupling. A film having such a configuration is called a DLC film. The overcoat layer 6 may be produced by means of sputtering or such. Alternatively, the overcoat layer 6 may be produced by means of a RF biased ECR plasma CVD process with the use of ethylene as a source gas. By using the RF biased ECR plasma CVD process, it is possible to produce the overcoat layer 6 superior in hardness, wearing characteristics, corrosion resistance, electrical strength, dielectric strength, chemical stability and so forth.

Next, an embodiment 3 will be described with reference to FIGS. 8 and 9. The embodiment 3 is a magnetic storage apparatus (i.e., a hard disk drive, for example) using the magnetic recording medium according to each of the embodiments 1 and 2. FIG. 8 depicts an internal partial side elevation of the magnetic storage apparatus in the embodiment 3, and FIG. 9 depicts an internal partial plan view of the magnetic storage apparatus in the embodiment 3.

As depicted in FIGS. 8 and 9, in the magnetic storage apparatus in the embodiment 3, a motor 14, a hub 15, a plurality of magnetic recording media 16, a plurality of magnetic heads 17, a plurality of suspensions 18, a plurality of arms 19 and an actuator unit 20 are provided in a housing 13. The magnetic recording media 16 are mounted on the hub 15 which is rotated by the motor 14. The magnetic heads 17 include reproduction heads such as MR heads or GMR heads, and recording heads such as inductive heads. Each of the magnetic heads 17 is mounted on an extending end of a corresponding one of the arms 19 via a corresponding one of the suspensions 18. The arms 19 are driven by the actuator unit 20. A basic arrangement of the magnetic storage apparatus, except the magnetic recording media 16 which will be described below, is well-known, and further description will be omitted.

As each of the magnetic recording media 16 of the magnetic storage apparatus according to the embodiment 3, the magnetic recording medium according to any one of the embodiments 1 and 2, described above with reference to FIGS. 1 through 7G, may be used. The specific number of the magnetic recording media 16 is not limited to 3 as depicted in FIG. 8. Instead, the specific number of the magnetic recording media 16 included in the magnetic storage apparatus may be one, or may be more than three.

Further, the basic arrangement of the magnetic storage apparatus is not limited to that depicted in FIGS. 8 and 9. Further, the magnetic recording media according to the embodiments are not limited to magnetic disks.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. A magnetic recording medium comprising:
a first upper layer;
a first lower layer below the first upper layer;
an intermediate layer, provided between the first upper layer and the first lower layer, which magnetically couples the first upper layer and the first lower layer, wherein:
the first lower layer comprises:
a second upper layer;
a second intermediate layer below the second upper layer; and
a second lower layer below the second intermediate layer,
coercive force of the first upper layer is higher than coercive force of each of the second upper layer and the second lower layer, and
the second upper layer and the second lower layer are antiferromagnetically coupled via the second intermediate layer.

2. The magnetic recording medium as claimed in claim 1, wherein:
the first upper layer is removed at an area between a first track area in which information is recorded and a second track area adjacent to the first track area.

3. The magnetic recording medium as claimed in claim 1, wherein:
non-magnetic material is provided in place of the first upper layer at an area between a first track area in which information is recorded and a second track area adjacent to the first track area.

4. The magnetic recording medium as claimed in claim 1, wherein:
a protective layer is provided in place of the first upper layer at an area between a first track area in which information is recorded and a second track area adjacent to the first track area, and the protective layer is further provided above the first upper layer at the first track area and the second track area.

5. The magnetic recording medium as claimed in claim 1, wherein:
coercive force of the second upper layer and the second lower layer is equal to or less than a third of coercive force of the first upper layer.

6. The magnetic recording medium as claimed in claim 2, wherein:
coercive force of the second upper layer and the second lower layer is equal to or less than a third of coercive force of the first upper layer.

7. The magnetic recording medium as claimed in claim 3, wherein:
coercive force of the second upper layer and the second lower layer is equal to or less than a third of coercive force of the first upper layer.

8. The magnetic recording medium as claimed in claim 4, wherein:
coercive force of the second upper layer and the second lower layer is equal to or less than a third of coercive force of the first upper layer.

9. A magnetic storage apparatus comprising:
the magnetic recording medium claimed in claim 1; and
a magnetic head which magnetically records information to the magnetic recording medium or magnetically reproduces information from the magnetic recording medium.

10. A magnetic storage apparatus comprising:
the magnetic recording medium claimed in claim 2; and
a magnetic head which magnetically records information to the magnetic recording medium or magnetically reproduces information from the magnetic recording medium.

11. A magnetic storage apparatus comprising:
the magnetic recording medium claimed in claim 3; and
a magnetic head which magnetically records information to the magnetic recording medium or magnetically reproduces information from the magnetic recording medium.

12. A magnetic storage apparatus comprising:
the magnetic recording medium claimed in claim 4; and
a magnetic head which magnetically records information to the magnetic recording medium or magnetically reproduces information from the magnetic recording medium.

13. A magnetic storage apparatus comprising:
the magnetic recording medium claimed in claim 5; and
a magnetic head which magnetically records information to the magnetic recording medium or magnetically reproduces information from the magnetic recording medium.

14. A magnetic storage apparatus comprising:
the magnetic recording medium claimed in claim 6; and
a magnetic head which magnetically records information to the magnetic recording medium or magnetically reproduces information from the magnetic recording medium.

15. A magnetic storage apparatus comprising:
the magnetic recording medium claimed in claim 7; and
a magnetic head which magnetically records information to the magnetic recording medium or magnetically reproduces information from the magnetic recording medium.

16. A magnetic storage apparatus comprising:
the magnetic recording medium claimed in claim 8; and
a magnetic head which magnetically records information to the magnetic recording medium or magnetically reproduces information from the magnetic recording medium.

17. A magnetic recording medium manufacturing method comprising:
forming a first lower layer by laminating, in sequence, a second lower layer, a second intermediate layer above the second lower layer, a second upper layer above the second intermediate layer; and
laminating, in sequence, the first lower layer, a first intermediate layer above the first lower layer and a first upper layer above the first intermediate layer, wherein:
the first intermediate layer magnetically couples the first lower layer and the first upper layer, and
coercive force of each of the second upper layer and the second lower layer is lower than coercive force of the first upper layer, and the second upper layer and the second lower layer are antiferromagnetically coupled via the second intermediate layer.

18. The magnetic recording medium manufacturing method as claimed in claim 17, comprising:
removing the first upper layer at an area between a first track area in which information is recorded and a second track area adjacent to the first track area.

19. The magnetic recording medium manufacturing method as claimed in claim 17, comprising:
providing non-magnetic material in place of the first upper layer at an area between a first track area in which information is recorded and a second track area adjacent to the first track area.

20. The magnetic recording medium manufacturing method as claimed in claim 17, comprising:
providing a protective layer in place of the first upper layer at an area between a first track area in which information is recorded and a second track area adjacent to the first track area, and further providing the protective layer above the first upper layer at the first track area and the second track area.
